(19) United States
(12) Patent Application Publication
(10) Pub. No.: US 2010/0068990 A1
(43) Pub. Date: Mar. 18, 2010

(54) ADAPTING VIDEO QUALITY TO AN EXTERNAL RENDERING DEVICE USING A MOBILE IPTV NETWORK

(76) Inventors: VINOD K. CHOYI, Ottawa (CA); YONG SUN, Kanata (CA)

Correspondence Address: WALL & TONG, LLP/;ALCATEL-LUCENT USA INC., 595 SHREWSBURY AVENUE, SHREWSBURY, NJ, 07702, US

(21) Appl. No.: 12/233,209

(22) Filed: Sep. 18, 2008

(51) Int. Cl. H04H 40/00

(52) U.S. Cl. 455/3.06

(57) ABSTRACT

An apparatus, system and methodology in which IPTV network-delivered content is adapted according to presentation characteristics of a rendering device coupled to a mobile phone, the mobile phone delivering the adapted content to the rendering device for presentation.

### FIELD OF THE INVENTION

The invention relates to the field of communications and, more specifically, to providing enhanced resolution media to a rendering device via a mobile device.

### BACKGROUND

Mobile television is rapidly gaining popularity around the world. Various applications are being developed to complement and leverage mobile TV. One of the problems associated with mobile TV is the resolution and screen size limits imposed by mobile devices. Specifically, mobile devices with relatively small screen sizes and/or relatively coarse resolution provide a correspondingly poorer viewing experience to the user. Mobile devices with relatively large screen sizes and/or relatively fine resolution provide a correspondingly better viewing experience to the user, though often at the expense of decreased battery life and increased size and weight.

### BRIEF SUMMARY

Various deficiencies of the prior art are addressed by the present invention of an apparatus, system and methodology in which IPTV network-delivered content is adapted according to presentation characteristics of a rendering device coupled to a mobile phone, the mobile phone delivering the adapted content to the rendering device for presentation.

One embodiment is a method for use in a mobile device in communication with a rendering device, the method comprising: determining presentation parameters associated with the rendering device; propagating to a server a content request and the determined presentation parameters; and receiving requested content from the server, the requested content conforming to the determined presentation parameters.

Another embodiment is a system comprising a mobile device, for communicating with a rendering device and a server; the mobile device propagating toward the server presentation parameters associated with the rendering device; the server propagating toward the mobile device content adapted according to the presentation parameters; and the mobile device receiving and processing the adapted content to provide a presentation signal suitable for use by the rendering device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an information distribution system according to one embodiment; and

FIG. 2 depicts a flow diagram of a method according to one embodiment.

To facilitate understanding, identical reference numerals have been used, where possible, to designate identical elements that are common to the figures.

### DETAILED DESCRIPTION OF THE INVENTION

The invention will be primarily described within the context of an apparatus, system and methodology in which IPTV network-delivered content is adapted according to presentation characteristics of a rendering device coupled to a mobile phone, the mobile phone delivering the adapted content to the rendering device for presentation.

Specifically, any mobile device (e.g., a mobile telephone) is used as a conduit to provide content to an existing rendering device (e.g., a display device in an automobile, train, airport lounge and/or other private or public locations). The operating characteristics and/or parameters associated with the rendering device are used by a content server to adapt or optimize the content for presentation by the rendering device. Those skilled in the art and informed by the teachings herein will realize that the invention is broadly applicable to any situation where a local device is capable of utilizing services delivered via a mobile access network.

For purposes of this discussion it is assumed that a rendering device comprises a television monitor, video monitor or other audiovisual presentation device having greater video resolution, screen size, audio quality and so on in comparison to a mobile device. Thus, rather than presenting imagery on the mobile device, the imagery is instead presented using the rendering device to enhance thereby the user experience. The IPTV imagery is supplied to the rendering device via a physical link between the mobile device and rendering device 150.

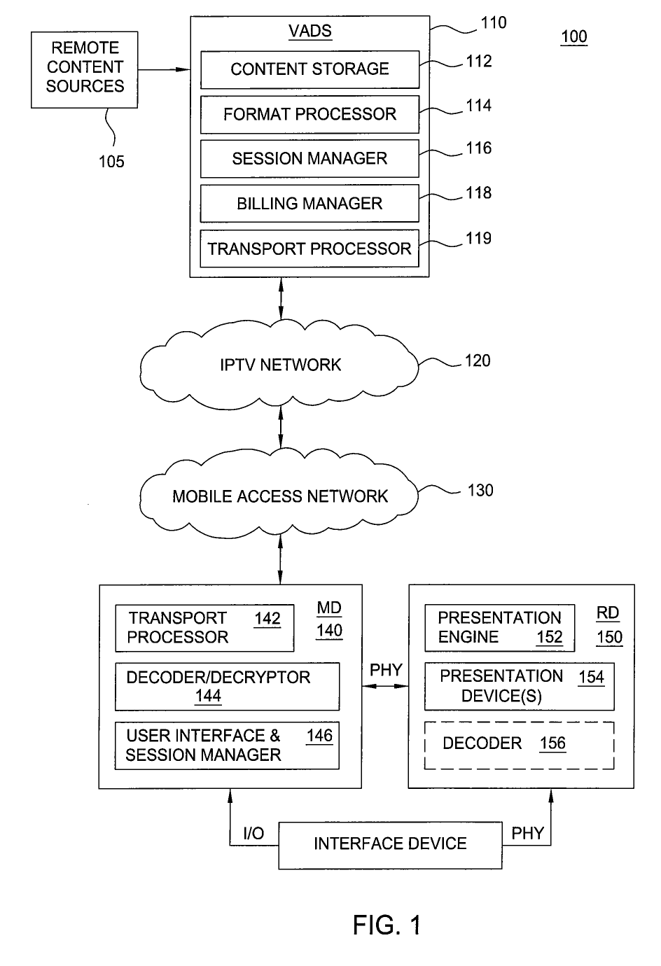

FIG. 1 depicts a high level block diagram of an information distribution system according to one embodiment. Specifically, the information distribution system 100 comprises a video adaptation and distribution server (VADS) 110, an Internet protocol television (IP TV) network 120, a mobile access network 130, a mobile device 140 and a rendering device 150.

For purposes of simplicity, detailed descriptions of the standard hardware and/or software functionality of servers, networks, mobile devices and rendering devices will be omitted. Thus, while not specifically described in detail, it will be appreciated by those skilled in the art that the mobile device 140 includes the hardware/software functional elements associated with a mobile telephone capable of communicating with the mobile access network 130 to request content from the server 110. Similarly, it will be appreciated by those skilled in the art that the server 110 includes the hardware/software functional elements associated with a server capable of interacting with the mobile device 140 to deliver thereto the requested content, which content is formatted in accordance with the presentation characteristics of the rendering device 150. It will also be appreciated by those skilled in the art that the rendering device 150 includes hardware/software functional elements associated with a rendering or presentation device capable of converting an input audiovisual signal (or streamed media signal) into respective video imagery and sound.

The mobile device 140 is coupled to the IPTV network 120 via the mobile access network 130. The video adaptation and distribution server 110 is also coupled to the IPTV network 120. Within the context of a content serving application, a session is established between the video adaptation and distribution server 110 and the mobile device 140. Thus, the mobile device 140 may provide content requests to the video adaptation and distribution server 110.

In a default mode of operation, the video adaptation and distribution server 110 provides the requested content to the mobile device 140 via the IPTV network 120 and mobile access network 130. In this case, the requested content is formatted in a manner adapted for presentation via the relatively low-quality mobile device display and speakers.

In an external rendering mode of operation, where the mobile device 140 is connected to a rendering device 150, the video adaptation and distribution server 110 formats requested content in accordance with the presentation characteristics of the rendering device 150. The presentation characteristics of the rendering device 150 are retrieved from the rendering device 150 by the mobile device 140 and then propagated to the video adaptation and distribution server 110.

The video adaptation and distribution server 110 comprises a content storage means 112, a format processor 114, a session manager 116, a billing manager 118 and a transport processor 119.

The content storage means 112 comprises a mass storage device or other mechanism for storing content for subsequent transmission to a mobile device. Optionally, the video adaptation and distribution server 110 retrieves content from remote content sources 105, such as broadcast television networks, remote storage sites and the like.

The format processor 114 adapts the format of content to be transmitted to a mobile device in accordance with the presentation characteristics of the mobile device or the rendering device coupled to the mobile device. The format processor 114 adapts one or more of the presentation characteristics associated with stored or streaming content, such as frame rate, frame size, resolution, color depth, audio quality and so on. In one embodiment, content retrieved from the content storage means 112 is processed by the format processor 114 and forwarded to the transport processor 119 for transport processing and subsequent propagation toward a mobile device 140. Alternatively, content files or streaming content is received from remote content sources 105, processed by the format processor 114 and forwarded to the transport processor 119.

The session manager 116 interacts with the mobile device 140 to establish a session through which the mobile device 140 may request content. It will be appreciated that the session manager 116 interacts with many mobile devices and/or other devices to receive content requests therefrom. The session manager 116 also receives presentation characteristic information from mobile devices pertaining to any rendering devices coupled to mobile devices.

The billing manager 118 cooperates with the session manager 116 to ensure that the user account associated with a mobile device 140 requesting content is billed as appropriate for the fulfillment of that request. In one embodiment, users are charged more for the higher resolution content files/streams adapted for use by a rendering device 150.

The transport processor 119 processes the requested content files/streams for subsequent transport to the mobile device 140 via the IPTV network 120. The transport processor 119 receives unmodified content files/streams from content storage means 112 or remote content sources 105, or modified/adapted content files/streams from format processor 114. The transport processor 119 provides transport mux/encoding functions, encryption functions and so on.

The IPTV network 120 and mobile access network 130 are standard communication networks.

The mobile device 140 comprises a transport processor 142, a decoder/decryptor 144 and the user interface and session manager 146. The transport processor is adapted to process the transport stream produced by the transport processor 119 of the video adaptation and distribution server 110 to extract therefrom audiovisual content streams. The decoder/decryptor 144 is adapted to process the extracted audiovisual content streams to provide audiovisual signals adapted for use by the rendering device 150. The user interface and session manager 146 is adapted to establish a session with the video adaptation and distribution server 110 for requesting content and supplying rendering device presentation characteristics, and for interacting with a user operating the mobile device 140 by keypad entry and/or voice control.

The mobile device 140 operates as a conduit between the video adaptation and distribution server 110 and the rendering device 150. The mobile device 140 provides control/signaling functions, transport demux/decoding functions, decryption functions and so on. Generally speaking, the invention is broadly applicable to any situation where a local device is capable of utilizing services delivered via a mobile access network in a more robust manner than the mobile device alone.

The mobile device 140 communicates with the rendering device 150 via a physical layer interface PHY. The physical layer interface PHY comprises a wired audiovisual link such as HDMI, S-video, VGA and so on. The audiovisual link they receive baseband audiovisual signals conforming to any standard format, such as NTSC, PAL, MPEG-2, MPEG-4, MPEG-7, DVB, VGA, S-VGA, X-VGA and the like. Alternatively, the physical layer interface PHY comprises a wired or wireless data link that provides compressed or uncompressed presentation data to the rendering device 150. Thus, the mobile device 140 and rendering device 150 share a common physical layer interface PHY supplying signals are conforming to a format to which both devices comply.

In one embodiment the mobile device comprises a mobile telephone including the various functionality described herein. In another embodiment, the mobile device comprises a standard mobile telephone (i.e., lacking the physical layer input output circuitry associated with the presentation engine 150). Thus, in one embodiment, an optional interface device 160 is used to support the physical layer interface PHY by coupling standard input output signals (I/O) of the mobile device 140 with the physical layer interface PHY adapted for the rendering device 150. In this embodiment, the functions of the interface device 160 are substantially similar to those described above with respect to mobile device 140 as related to propagation of requested content to the rendering device 150. In one embodiment, the input/output signals of the mobile device 140 comprises universal serial bus (USB) or other standard and nonstandard communication links built into mobile telephones.

Optionally, I/O interface device 160 is used to support the physical layer interface PHY. The format of the content provided to the rendering device 150 is modified as necessary based upon the headend bandwidth constraints imposed by the input/output signals of the mobile device 140. In this embodiment, the mobile device 140 detects the rendering device presentation parameters and modifies the presentation parameters propagated to the VADS 110 such that the resulting content does not exceed the capabilities of the mobile device 140.

Although most rendering devices 150 are adapted to receive standard input signals, the inventors also contemplate that some rendering devices will accept non-standard audiovisual input signals including signals conforming to various telecommunications and/or computer network formats. In one embodiment, the mobile device performs functions similar to that of an SVGA or VGA card; namely, providing electrical signals adapted to be processed by a compatible video monitor or rendering device.

The rendering device 150 comprises a presentation engine 152, one or more presentation devices 154 and, optionally, a decoder 156. The presentation engine 152 comprises the standard circuitry used to convert individual input signals received by the physical layer interface PHY into signals suitable for use by the presentation devices 154. The presentation devices 154 comprise COM illustratively, a liquid crystal display (LCD) display screen and one or more audio speakers. The optional decoder 156 is adapted to decode and/or otherwise process compressed or uncompressed audiovisual data supplied by the mobile device 140. In one embodiment, the optional decoder 156 comprises an MPEG decoder and the mobile device 140 provides MPEG encoded streams to render device 150 via the physical layer PHY.

Advantageously, off-loading the rendering function to a separately powered rendering device such as a television or monitor reduces the consumption of battery power in the mobile device.

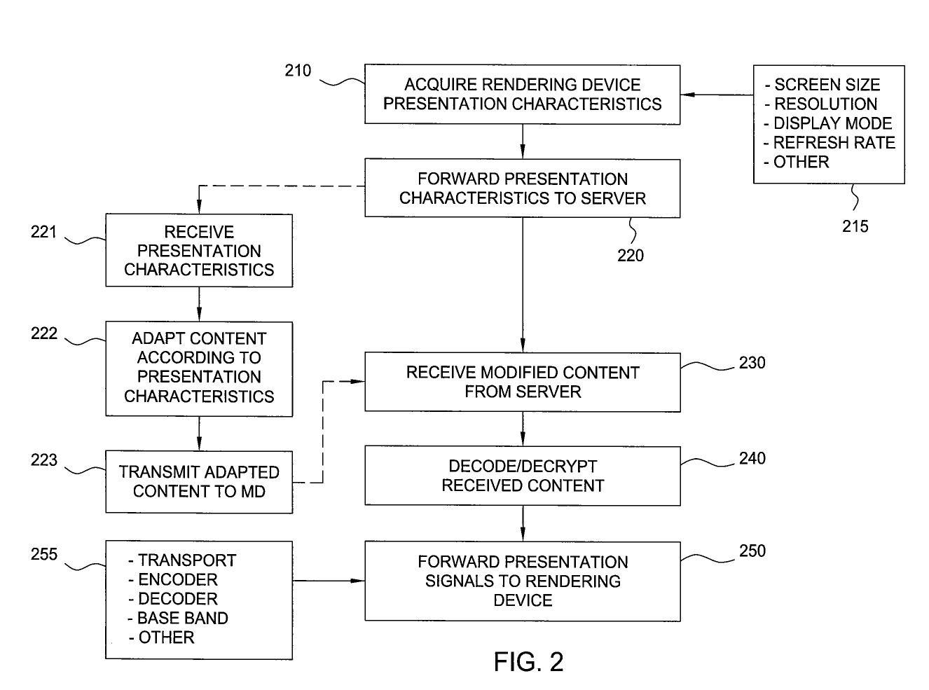

FIG. 2 depicts a flow diagram of a method according to one embodiment. Specifically, at step 210 presentation characteristics associated with a rendering device are acquired by, for example, a mobile device. The presentation characteristics may be pulled from the rendering device by the mobile device (e.g., via a query to the rendering device) or pushed from the rendering device to the mobile device (e.g., upon connection of the rendering device to the mobile device via the physical layer PHY). Referring to box 215, such presentation characteristics comprise one or more of screen size, screen resolution, display mode, refresh rate as well as other audio and/or video presentation characteristics including those discussed above with respect to FIG. 1.

At step 220, the mobile device forwards the rendering device presentation characteristics to a server, such as the video adaptation and distribution server 110.

At step 221, the server receives the presentation characteristics of the rendering device from the mobile device via the IPTV network or other communication/control means. At step 222, the server adapts requested broadcast content intended for the mobile device according to the presentation characteristics received from the mobile device. At step 223, the server transmits the data content to the mobile device.

At step 230, modified content is received from the server. That is, the server adapts requested or broadcast content in conformance with the presentation characteristics of the rendering device and forwards the adapted content to the mobile device. At step 240, the mobile device decodes and decrypts as necessary the data content received from the server to produce thereby presentation signals suitable for use by the rendering device. At step 250, the mobile device forwards the presentation signals to the rendering device for subsequent presentation by the rendering device. Referring to box 255, the presentation signals may comprise baseband audiovisual signals, decoded audiovisual signals, encoded audiovisual signals, transport encoded audiovisual signals and the like. The rendering device responsively presents the content supplied via the presentation signals.

The above-described method 200 of FIG. 2 indicates that the mobile device 140 decodes and/or decrypts received content (step 240). In one embodiment, the decode and/or decrypt step is performed by circuitry within the rendering device 150.

Thus, existing televisions, monitors and other rendering devices available at various locations such as public/private transportation vehicles, stations and the like are used in a manner providing more pleasurable, worthwhile and directed content to the end-user. These embodiments make use of better resolution and bigger sized screens to view Mobile TV content. The actual transport of the content from the content or Video Distribution and Adaptation Server to the TV is provided via the mobile device (such as a handset, mobile phone, PDA like), operating as a set-top box delivering content to the rendering device.

In one embodiment, mobile telephones are manufactured to include any suitable physical layer interface, such as the VGA, HDMI and/or other interface described above. In short, any physical layer interface that enables a mobile telephone to be physically connected to an external rendering device such as a television, monitor or other audiovisual display device may be incorporated within a mobile telephone at the time of its manufacture. In other embodiments, standard input output circuitry within existing mobile telephones is linked to an external interface device capable of converting mobile telephone standard input output signals to signals of a format suitable for use by rendering device. These various embodiments benefit from additional software loaded in the processing circuitry of a mobile phone to detect various formats associated with a rendering device, conform non-audiovisual signals within the mobile phone into physical layer of audiovisual signals suitable for use by the rendering device (where such signals are not provided by the network) and so on.

In various embodiments, mobile telephones, rendering devices, servers, clients, routers, access elements and/or other network elements are discussed herein. Each of these network elements and devices comprises at least one processor, various support circuitry, input-output (I/O) circuitry, memory, communication buses and so on for receiving, processing, providing and/or exchanging information. The at least one processor may be any conventional processor for executing programs stored in memory. The memory may be any conventional volatile memory (e.g., RAM, DRAM, among others), non-volatile memory (e.g., disk drives, floppy, drives, CDROM, EPROMS, among other computer readable medium) or any other conventional memory device for storing data and various control programs, such as methodology according to the present invention. The processor cooperates with conventional support circuitry, such as power supplies, clock circuits, cache memory and the like, as well as circuits that assist in executing the various programs and routines, as well as other programs and data. As such, it is contemplated that some of the process steps discussed herein as software processes may be implemented within hardware, for example, as circuitry that cooperates with the processor to perform various steps. The input/output (I/O) circuitry forms an interface between the various functional elements communicating with each network element.

Although the mobile phone and other devices described herein are depicted as a general-purpose computer that is programmed to perform various control functions in accordance with the present invention, the invention can be implemented in hardware such as, for example, an application specific integrated circuit (ASIC). As such, it is intended that the processes described herein be broadly interpreted as being equivalently performed by software, hardware, or a combination thereof.

The invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for use in a mobile device in communication with a rendering device, comprising:
determining presentation parameters associated with the rendering device;
propagating to a server a content request and said determined presentation parameters;
receiving requested content from said server, said requested content conforming to said determined presentation parameters; and
forwarding the requested content to the rendering device.

2. The method of claim 1, wherein the mobile device comprises a mobile telephone.

3. The method of claim 2, wherein a content request is propagated to the server via an IPTV network in communication with a mobile access network associated with the mobile device.

4. The method of claim 1, wherein the requested content is encrypted and the method further comprises:
decrypting, at the rendering device, content received via the mobile device.

5. The method of claim 1, wherein the requested content is encrypted and the method further comprises:
decrypting, at the mobile device, content received via the mobile device.

6. The method of claim number 1, further comprising:
modifying the presentation parameters associated with the rendering device to constrain the bandwidth of a resulting content stream to the capabilities of the mobile device.

7. The method of claim 1, wherein the requested content is forwarded to the rendering device via an audiovisual interface.

8. The method of claim 6, wherein the audiovisual interface comprises any of an HDMI interface, a S-video interface and a VGA interface.

9. A method, comprising:
receiving at a server a request for content and presentation parameters associated with a rendering device;
processing the requested content according to the presentation parameters to produce thereby a content stream adapted for use by the rendering device; and
propagating the content stream toward a mobile device in communication with the rendering device.

10. The method of claim 9, wherein:
the server communicates with the mobile device via an IPTV network.

11. The method of claim 9, wherein:
the mobile device communicates with the IPTV network via a mobile access network.

12. Apparatus, comprising:
a server, for propagating toward a mobile device content requested by the mobile device and adapted to conform to a presentation format indicated by the mobile device.

13. The apparatus of claim 12, wherein the presentation format indicated by the mobile device is associated with the rendering device coupled to the mobile device.

14. The apparatus of claim 12, wherein:
the server encrypts the adapted content for delivery to the mobile device via an IPTV network; and
the mobile device decrypts the data content for delivery to the rendering device.

15. The apparatus of claim 12, wherein the presentation signal comprises a digital video signal.

16. The apparatus of claim 12, wherein the presentation signal comprises one of an HDMI signal, an S-video signal and a VGA signal.

17. A system, comprising:
a mobile device, for communicating with a rendering device and a server;
the mobile device propagating toward the server presentation parameters associated with the rendering device;
the server propagating toward the mobile device content adapted according to the presentation parameters; and
the mobile device receiving and processing the adapted content to provide a presentation signal suitable for use by the rendering device.

18. The system of claim 17, wherein:
the server communicates with an IPTV network; and
the mobile device communicates with a mobile access network in communication with the IPTV network.

19. The system of claim 17, wherein:
the server encodes the adapted content for delivery to the mobile device via an IPTV network; and
the mobile device decodes the data content for delivery to the rendering device.

20. The system of claim 17, wherein:
the server encrypts the adapted content for delivery to the mobile device via an IPTV network; and
the mobile device decrypts the data content for delivery to the rendering device.

21. The system of claim 17, wherein the presentation signal comprises a digital video signal.

22. The system of claim 17, wherein the presentation signal comprises one of an HDMI signal, an S-video signal and a VGA signal.
